(19) United States
(12) Patent Application Publication
(10) Pub. No.: US 2023/0382777 A1
(43) Pub. Date: Nov. 30, 2023

(54) INTEGRATED THERMAL HYDROLYSIS AND VACUUM DIGESTION FOR TREATING FLUID USING A BIOCHEMICAL PROCESS

(71) Applicant: U.S. PEROXIDE, LLC, Atlanta, GA (US)

(72) Inventors: Farokh Laqa KAKAR, North York (CA); Ahmed Abdelmalek AL OMARI, Aldie, VA (US); Christopher Dustin MULLER, Londonderry, NH (US); Elsayed ELBESHBISHY, Missisauga (CA)

(73) Assignee: U.S. PEROXIDE, LLC, Atlanta, GA (US)

(21) Appl. No.: 18/199,548

(22) Filed: May 19, 2023

Related U.S. Application Data
(60) Provisional application No. 63/343,903, filed on May 19, 2022.

(51) Int. Cl. C02F 9/00

(52) U.S. Cl. CPC C02F 9/00; C02F 11/18

(57) ABSTRACT

A system and method for treating a fluid that includes a particulate fraction and a soluble fraction includes feeding the fluid to a hydrothermal treatment apparatus and subjecting the fluid to heating to a temperature of 121° C. or more to obtain treated fluid, subsequently feeding the hydrothermally treated fluid to a vacuum-integrated reactor, wherein at least the particulate fraction is subjected to fermentation or digestion, during the fermentation or digestion, subjecting the fluid in the vacuum-integrated reactor to a vacuum pressure, and collecting from the vacuum-integrated reactor at least a portion of the soluble fraction of the fluid as condensate and thereby thickening a remaining portion of the fluid, and recovering thickened fluid from the vacuum-integrated reactor. The vacuum may also be applied upstream or downstream of and separate from a non-vacuum-integrated reactor.

The present application is a non-provisional application of U.S. Provisional App. No. 63/343,903 filed May 19, 2022, the disclosure of which is incorporated herein by reference in its entirety.

### BACKGROUND

Global climate change and energy crisis due to fossil fuel combustion have increased the interest in the bio-renewable energy resource. Therefore, the wastewater treatment plants (WWTP) are shifting towards water resource recovery facilities (WRRF), targeting wastewater treatment and value-added products recoveries such as volatile fatty acids and biomethane from produced sludge on-site. Furthermore, in recent years, due to the economic conditions such as increasing oil prices as well as the negative environmental impacts, government initiatives in many countries are focusing on the increased use of various renewable energies, including solar, wind, biomass, hydropower, tidal power, and energy from waste.

One of the leading sludge management technologies is anaerobic digestion. Anaerobic digestion (AD) is a promising technology that can convert the organic wastes to either volatile fatty acids or methane or both in two distinct phases: acidification (first phase) and methanogenesis (second phase). The organic wastes are converted to volatile fatty acids via acidogenesis and acetogenesis microorganisms in the first phase. Further, the hydrogen and volatile fatty acids are converted to methane via methanogenesis in the second phase. AD has many benefits, such as solid reduction, decreasing greenhouse gas emissions, odor reduction, and increasing non-market benefits compared to the other waste treatment technologies.

Long hydraulic retention times of the soluble fraction of a fluid (HRT) and low methane and VFA yield are some of the challenges associated with anaerobic digestion (AD). The hydrolysis step is the rate-limiting step for AD of complex organic fluids or substrates, whereas methanogenesis is the rate-limiting step for easily biodegradable fluids or substrates. Different pretreatment technologies, including mechanical, chemical, biological, and thermal, have been applied in an effort to promote the hydrolysis step. Hydrothermal treatment (HTP) refers to the heating of the biomass beyond autoclave temperature (121° C.) in a fixed time before AD. The mechanism of HTP is disintegrating the cell membrane and subsequently releasing the intracellular materials, which results in solubilization of the organic compounds. Researchers studied the effect of HTP on both AD and fermentation of the municipal sludge using wide range of temperatures (from 50° C. to 275° C.).

### SUMMARY

What is still desired is a method and system to improve the efficiency, for example in terms of increasing the yield of value-added products such as volatile fatty acids and biomethane and retention time, of the anaerobic digestion process in processing a fluid such as sludge, for example in a wastewater treatment facility.

This and other objects are achieved by the novel system and method described herein.

The disclosed system and method addresses the recalcitrant nature of organic waste such as waste-activated sludge to conventional anaerobic digestion. The addition of a hydrothermal pretreatment (HTP) reduces the potential for mixing issues due to sludge thickening in the vacuum reactor. Generally, mixing of the digesters requires significant amount of energy due to high viscosity of the sludge. HTP reduces the viscosity of the sludge and facilitates easier operation and less maintenance. In addition, smaller AD volume will be required due to ability to operate the digester with more concentrated feed due to reduction in viscosity.

The combination of the HTP and vacuum digestion helps overcome the limitations of each process separately, as vacuum digestion is viscosity-limited, and thermal treatment is ammonia limited (ammonia produced during HTP is inhibitory to AD). The present application overcomes these limitations by combining their individual strengths. The thermal treatment would lower the viscosity, hence de-bottlenecking vacuum digestion, and vacuum digestion will lower the ammonia comment (by vacuum stripping under boiling), which will de-bottleneck the thermal treatment. Additional synergies are also anticipated: for example, the use of a nearly perfect biomass retention process (vacuum extraction/evaporation) allows for selection of microbial ecologies specialized on the less digestible component of the thermally treated feed. This way, the less biodegradable components existing in the feed or generated by HTP, can be converted by specialized organisms efficiently. Moreover, the liquid residues generated by the integrated process are not affected by the presence of non-biodegradable total nitrogen, since the latter is retained in the cake and further digested by specialized microbial groups.

The disclosed system and method aim to minimize the spatial requirement for anaerobic digesters, while enhancing production of resources like VFA and diverting this carbon source to other processes in the wastewater treatment facility. Typically, AD tanks have large footprints depending on the capacity of the plants. Hydraulic retention time and loading rate of the AD dictate the volume of the digester that need to be designed and built. With population growth in urban areas, most plants need to increase their digestion capacity by loading more organics to the digester. However, sending higher loads to digesters means operating the digester with lower HRTs. The biosolids produced by lower HRTs do not meet the biosolids standards in many countries, compelling utilities to build new digesters to handle the higher loads. The novel combination of hydrothermal treatment with vacuum digestion technology described herein not only allows the digester to run in lower HRTs by decoupling hydraulic retention time of the soluble fraction (HRT of the soluble component of a fluid being treated) from the residence time of the solids fraction of the fluid being treated (HRT of the solids component of the fluid, or SRT), but also enhances methane and/or hydrogen production. High ammonia concentrations and associated pH after HTP result in high free ammonia concentrations causing inhibition of methanogenesis. This inhibition can be addressed by the disclosed system and method.

The subject matter herein thus includes a method for treating a fluid that includes a particulate fraction and a soluble fraction, the method comprising:
feeding the fluid to a hydrothermal treatment apparatus and subjecting the fluid to heating to a temperature of 121° C. or more to obtain treated fluid;
subsequently feeding the hydrothermally treated fluid to a reactor, wherein at least the particulate fraction is subjected to fermentation or anaerobic digestion, wherein the treated fluid is subjected to vacuum pressure upstream in a process direction from the fermentation or anaerobic digestion, during the fermentation or anaerobic digestion, or downstream in a process direction from the fermentation or anaerobic digestion;
wherein if the vacuum pressure is applied during the fermentation or anaerobic digestion, the reactor is a vacuum-integrated reactor, and the method includes collecting from the vacuum-integrated reactor at least a portion of the soluble fraction of the fluid (including water and gases) as condensate and residual gases and thereby thickening a remaining portion of the fluid;
wherein if the vacuum pressure is applied upstream or downstream of the fermentation or anaerobic digestion, the method includes collecting from the treated fluid or from the treated and fermented or digested fluid at least a portion of the soluble fraction of the fluid (including water and gases) as condensate and residual gases and thereby thickening a remaining portion of the fluid; and
recovering the thickened fluid.

Also described is a method for treating wastewater fluid that includes biosolids, the method comprising:
feeding the wastewater fluid to a hydrothermal treatment apparatus and subjecting the fluid to heating to a temperature of 121° C. or more to obtain treated fluid;
subsequently feeding the treated fluid to a reactor, wherein the wastewater fluid is subjected to fermentation or anaerobic digestion, wherein the treated fluid is subjected to vacuum pressure upstream in a process direction from the fermentation or anaerobic digestion, during the fermentation or anaerobic digestion, or downstream in a process direction from the fermentation or anaerobic digestion;
wherein if the vacuum pressure is applied during the fermentation or anaerobic digestion, the reactor is a vacuum-integrated reactor, and the method includes collecting from the vacuum-integrated reactor gases including but not limited to ammonia as condensate;
wherein if the vacuum pressure is applied upstream or downstream of the fermentation or anaerobic digestion, the method includes collecting from the treated fluid or the treated and fermented or digested fluid gases including but not limited to ammonia as condensate; and
extracting heat from the condensate and using the extracted heat to provide heating to the wastewater fluid in the hydrothermal treatment apparatus.

Still further described is a system for treating a fluid that includes a particulate fraction and a soluble fraction, the system comprising:
a hydrothermal treatment apparatus configured to treat a fluid fed therein by heating,
downstream in a process direction from the hydrothermal treatment apparatus, a reactor configured to receive the treated fluid from the hydrothermal treatment apparatus, to subject the treated fluid to fermentation or anaerobic digestion, wherein the reactor is selected from a vacuum-integrated reactor having a vacuum pump for applying a vacuum to the vacuum-integrated reactor and a reactor without a vacuum pump,
wherein if the reactor is a reactor without a vacuum pump, the system further includes a second reactor or line, either upstream in a process direction from the reactor or downstream in a process direction from the reactor, that includes a vacuum pump for applying a vacuum to the second reactor or line, and
wherein using the vacuum, condensate is removed; and
a controller configured to control application of the vacuum and removal of the condensate.

### BRIEF DESCRIPTION OF THE DRAWINGS

FIG. 1 is an illustration of a system including both a hydrothermal treatment apparatus and vacuum-integrated reactor in a system including a downstream anaerobic digester.

FIG. 2 is an illustration of a system including a hydrothermal treatment apparatus, a reactor and a downstream vacuum-integrated treatment unit.

FIG. 3 is an illustration of a system including both a hydrothermal treatment apparatus and vacuum-integrated reactor in a system including an upstream anaerobic digester.

FIGS. 4-7 illustrate specific example systems employing both hydrothermal treatment (HTP), in this case with heating derived through means including heat recovery from condensate extracted from the digestion process, and vacuum digestion.

FIG. 8 illustrates the different soluble components, such as the VFAs, soluble carbohydrates, and soluble protein concentrations, for hydrothermally treated and raw untreated samples.

FIG. 9 illustrates the percentages reduction in TSS and VSS due to the hydrothermal treatment.

FIG. 10 illustrates the particle size distribution (PSD) of raw and hydrothermally treated (HTP) samples.

FIG. 11 illustrates the changes in chemical oxygen demand (COD) solubilization by time in a conventional and a vacuum fermentation reactor fed by HTP treated sludge.

FIG. 12 shows the changes in COD solubilization of sludge by the time in two reactors (vacuum and conventional).

FIG. 13 shows the average COD solubilization for four systems (conventional fermentation, HTP treated sludge with conventional fermentation, vacuum fermentation, and HTP treated sludge with vacuum fermentation).

FIG. 14 shows the variation of VFA yield by time for the treated samples in a conventional and vacuum-integrated reactor for the fermentate, condensate, and overall fermentate+condensate.

FIGS. 15 and 16 show specific denitrification rate (SDR) and biomass yield for all carbon sources.

FIGS. 17 and 18 show the cumulative methane production yield by time for the four systems.

FIGS. 19 and 20 show the HTP treated and raw untreated feed's methane production rates.

### DETAILED DESCRIPTION OF EMBODIMENTS

Described herein is a system and method that includes both a hydrothermal treatment apparatus and a vacuum-integrated biotic and abiotic reactor (e.g., fermenter). In one aspect, this disclosure provides a system and method for treating a fluid that includes a particulate fraction and a soluble fraction. The system and method may include biochemically transforming solids in the particulate fraction of the fluid with microbes (e.g., for fermentation) while simultaneously subjecting the fluid to a vacuum pressure, and evaporating off at least a portion of the soluble fraction of the fluid and thereby thickening a remaining portion of the fluid, which may remain in the vacuum-integrated reactor for continued treatment. The system and method are used in support of a system and method using fermentation and/or anaerobic digestion (AD) to process the fluid.

AD is a multi-step biochemical process in which organic waste materials are broken down by the causation of facultative and anaerobic microorganisms in an oxygen-free environment, where the basic steps of anaerobic digestion are hydrolysis, acidogenesis, acetogenesis, and methanogenesis.

In the first step, hydrolysis, hydrolytic bacteria degrade the complex organic polymers such as proteins, carbohydrates, and lipids into soluble monomers. In waste-activated sludge (WAS), a major part of the organic compounds is bordered in a polymeric network formed by extracellular polymeric substances (EPSs). EPSs are highly hydrated structures with importance in bio flocculation, settling, and dewatering the sludge. EPS in WAS is mainly attributed to the proteins and carbohydrates which need to be disintegrated to make the intracellular content available to the microorganisms.

The second step is acidogenesis, for example fermentation, where the products of hydrolysis further degrade to form volatile fatty acids (VFA) such as acetic acid, propionic acid, butyric acid, iso-butyric acid, valeric acids, and the like, ammonia, hydrogen sulfide, carbon dioxide, and other by-products. In the present disclosure, the vacuum-integrated reactor is used for this step, which also leads to the solubilization of organic matters.

The next step, acetogenesis, involves acetogenic bacteria which convert organic acids into acetic acid, hydrogen, and carbon dioxide.

The final stage of anaerobic digestion is methanogenesis, wherein biomethane is produced by two groups of methanogenic organisms: acetoclastic methanogens, which degrade acetate into methane and carbon dioxide, and hydrogenophilic methanogens, which use hydrogen as an electron donor and carbon dioxide as an acceptor to produce methane. Additionally, methanogenesis can be controlled to favor the formation of biohydrogen and/or bioethanol rather than biomethane.

Anaerobic digestion thus treats and stabilizes the sludge and recovers value-added products in the form of methane or hydrogen and volatile fatty acids (VFA) through fermentation. The VFA recovered from the fermented sludge can be used for several applications such as a carbon source for biological nutrient removal on-site, biodegradable plastics production, and hydrogen production.

The systems and methods herein are focused on the application and integration of a vacuum pump to extract water and gas from sludge streams with existing bioprocesses used for solids treatment such as fermentation or digestion. The vacuum is applied integrated with the bioprocess where the pump is connected to the headspace of the bioprocess vessel, or the vacuum can be applied in a standalone vessel or stream that is hydraulically connected to the main bioprocess reactor. In one embodiment, thermally pretreated feed fluid is fed to a vacuum-integrated reactor, e.g., a fermenter or digester with a vacuum pump associated therewith for applying a vacuum to the vacuum-integrated reactor, in an in-situ method. In another embodiment, thermally pre-treated fluid is fed to a reactor (without a vacuum) and separately to a vacuum-integrated side stream treatment unit located either upstream or downstream from the reactor, in an ex-situ method. In these embodiments, the reactor may be, for example, a fermenter and/or an anaerobic digester. Fermenters and anaerobic digesters are both well-known reactors in the art, and the differences in operation are thus not further discussed herein.

Hydrothermal treatment (HTP) is thus used in the system and method described herein as a step ahead of, in the order of the method, vacuum-integrated digestion or fermentation in the vacuum-integrated reactor. The HTP disintegrates wastewater sludge, increases soluble chemical oxygen demand (SCOD), breaks down the cell walls of the bacteria contained in the sludge, releasing the intracellular substances, and reduces sludge viscosity.

The reactor, downstream, in a process direction, from the HTP apparatus, is used to separate high quality condensate containing volatile materials such as VFA and ammonia and concentrate inert and particulate solids into a smaller volume. The reactor may be a fermentation reactor (fermenter) or a digestion reactor (digester), and as discussed below may include means for applying a vacuum therein such as a vacuum pump or may omit means for applying a vacuum (a vacuum-integrated reactor). By integrating HTP with the reactor, production of valuable materials like VFA can be enhanced, increasing their recovery in the condensate. In addition, the tendency for mixing issues is reduced.

In prior systems, low methane and VFA yield are due in part to the accumulation of inhibitory compounds such as ammonia and other nutrients during fermentation and AD. Removal of these inhibitory compounds improves the system significantly. Applying a vacuum to the fermenter or digester allows decoupling of HRT from solids retention time (SRT) via vacuum evaporation, leading to a compact process deployed at a broader range of facilities, including small municipalities and farms. In addition, this novel approach can facilitate the separation and recovery of resources such as ammonia and VFAs, while simultaneously enhancing sludge thickening.

The system and method herein combines the HTP of organic waste with digestion or fermentation and a vacuum. A slowly biodegradable fluid or substrate, for example a fluid or solid that includes recalcitrant organics, such as thickened waste activated sludge (TWAS) and/or food waste, goes through the hydrothermal treatment (HTP). The slowly biodegradable fluid or substrate used for the HTP can be any recalcitrant organic biodegradable compounds including but not limited to TWAS, manure, source separated organics (SSO), yard waste, and cellulosic and lignocellulosic matters. The pH of the slowly biodegradable substrate such as sludge can be acidic, neutral, or alkaline, ranging from, for example, 4-10. The solids content of the hardly biodegradable substrate may range from, for example, 1% to 20%, such as 1% to 16%.

The HTP apparatus may be any suitable apparatus with an inlet for the feed fluid or substrate, means for applying heat to the feed fluid or substrate within the apparatus, such as an external heat source or from a heat exchanger that extracts heat from other materials within the system, such as sludge exiting the HTP apparatus and/or condensate from the vacuum reactor, and an exit for the treated fluid or substrate. The HTP apparatus thus may utilize heat recovered from the condensate gases removed by the vacuum from the vacuum reactor to hydrothermally treat the feed fluid.

The HTP can be conducted in a temperature range of, for example, 130 to 300° C., such as 150 to 220° C., for a duration of, for example, 5 to 300 minutes, such as 5 to 100 minutes and 10 to 30 minutes. The HTP may be conducted at normal atmospheric pressure, but can also be conducted under pressure of, for example, 1.1 to 10 bar, such as 2 to 8 bar or 2 to 6 bar. A preferred set of conditions for low retention time is, for example, 170° C., 6 bar, 30 minutes. Optimal temperature and retention time of the HTP for methane production purposes are 160 to 180° C. and 20 to 40 minutes, respectively.

The HTP can increase the concentration of all soluble compounds, including soluble proteins, volatile fatty acids and carbohydrates, in the fluid compared to the raw untreated fluid. Correspondingly, the content of total suspended solids (TSS) and volatile suspended solids (VSS) can be reduced by HTP compared to the raw untreated fluid. For example, the TSS reduction may range from, for example, 10% to about 40% such as 15% to 35% or 20% to 35%, while VSS reduction may range from, for example, 10% to about 50% such as 15% to 40% or 20% to 40%. Further, HTP can lower the particle size of the treated fluid compared to the raw untreated fluid. For example, where d10 and d90 of a raw sample are 27 and 187 μm, respectively, HTP may reduce the values to 15 and 125 μm, respectively, with increasing the retention time in the HTP decreasing the particle size of the treated samples. These changes to the treated fluids are significant, as it enables higher value-added product recovery from the anaerobic digestion process, including higher VFA yields and higher methane and/or hydrogen recovery and production.

Upon exiting the HTP apparatus, the treated fluid, such as treated sludge, may then be mixed with faster biodegradable fluids or substrates, i.e., fluids or substrates that biodegrade at a rate faster than the biodegradation rate of the slowly biodegradable fluid or substrate, such as primary sludge. The additional fluid is thus more rapidly biodegraded than the slowly biodegradable fluid in that it can be more rapidly biodegraded, for example by fermentation. If mixed, a ratio between the two types of the fluids or substrates (slowly biodegradable:more rapid biodegradable) depends on the characteristics of the materials, but may range between 100:0 to 25:75, such as 75:25 to 25:75, preferably 50:50.

The treated material exiting the HTP apparatus, optionally in mixture with non-treated fluids or substrates, gets fed to the reactor (digester or fermenter). Preferably, in order to facilitate the fermentation and digestion process in the reactor, the treated material is cooled to 75° C. or less prior to entry into the reactor. The cooling may be achieved using ambient conditions, or may be facilitated through any suitable active cooling method and/or heat removal in a heat exchanger (in which case any extracted heat may be re-used in heating additional fluid or substrate in the HTP apparatus).

As the reactor, a conventional fermentation or digestion apparatus and design may be used. In one embodiment, the fermenter or digester includes means for applying a vacuum to the reactor, such that during the fermentation or digestion, a vacuum is applied and condensate (such as water and ammonia) are removed from the reactor during the fermentation or digestion process. The condensate removed via the vacuum is used, for example, for a biological nutrient removal (BNR) process and the remaining fermentate exiting the vacuum-integrated reactor may be directed to an anaerobic digester, a post-pasteurization device, and/or a dewatering unit.

An example of the vacuum-integrated reactor of the system and method described herein, and conditions for operating the vacuum-integrated reactor, is described in U.S. patent application Ser. No. 17/742,905, incorporated herein by reference in its entirety.

In an alternative embodiment, the reactor is a conventional fermenter or digester, without a vacuum, in which case the system and method then further include, upstream, downstream or both in a process direction from the fermenter or digester, a treatment unit or feed line (collectively referred to herein as a vacuum-integrated treatment unit) that has a vacuum associated therewith. In this embodiment, fermented/digested material exiting the reactor is subjected to the vacuum in order to remove condensate as described above.

Fermentation in the reactor can run under mesophilic, thermophilic, or hyperthermophilic conditions, with a temperature range of, for example, 20 to 100° C., preferably 20 to 70° C. The pH can be adjusted using acids or bases to obtain acidic, neutral, or alkaline conditions ranging between, for example, 3-10. Vacuum may reduce the required base added due to additional stripping of CO2 gas from the reactor.

The vacuum used herein can be operated so that the treatment chamber is from, for example, 1 to 999 mbar, from 10 to 750 mbar, from 25 to 500 mbar, from 25 to 400 mbar, or from 25 to 300 mbar. This vacuum pressure can be achieved by using a vacuum pump. The vacuum can be applied intermittently, including periodically, so that the treatment chamber has periods where the fluid is being biochemically treated under vacuum pressure and periods where the fluid is being biochemically treated at greater than vacuum pressure. The treatment can occur so that the fluid is treated at pressures greater than vacuum pressure for a duration that is equal to or longer (e.g., 1 to 100 times longer, 2 to 50 times longer, or 4 to 25 times longer) than the periods at which the fluid is treated at a vacuum pressure.

The vacuum pump can be controlled by an automatic controller that maintains the treatment chamber at the desired pressure, shuts off the vacuum at desired times (e.g., based on the amount of condensate collected), etc. The temperature can be in the range from, for example, 10 to 90° C., from 20 to 80° C., from 30 to 70° C., or from 40 to 50° C. The vacuum pressure can be controlled so that the treated fluid boils in these desired temperature ranges. The treatment chamber can be heated by any suitable means, such as using heated streams from other parts of the system or using an electrical heat element. The pH of the fermentate/digestate can be maintained in the range of from, for example, 3 to 10, 4 to 9, 5 to 8 or 5.5 to 6.5. pH and/or temperature adjustments can be made during the process to concentrate desired chemicals in either the evaporate or the fermentate/digestate. The controller can be configured to not only control the removal rate of condensate from the vacuum reactor or treatment unit, but also to control a residence time of the solids (particulate fraction) of the fluid being treated to be at least 25% greater than a residence time of the soluble fraction within the vacuum reactor or treatment unit.

Two streams exit the vacuum-integrated reactor or vacuum-integrated treatment unit, (1) the condensate stream comprised of the soluble fraction removed from the reactor via the vacuum, and (2) the fermentate/digestate stream comprised of the remainder, which is comprised primarily of the solids fraction of the fluid. The fermentate/digestate has a higher solids content than the HTP treated fluid entering the vacuum unit.

The reactor can run with a hydraulic retention time of the soluble fraction of the fluid being treated (HRT) of, for example, 0-3 days, such as 0.1-3 days or 1-3 days and a solids fraction retention time (SRT) of, for example, 0.5-10 days or more, for example 1-5 days or 2-3 days. For example, while a typical retention time of the soluble fraction (water and volatile compounds) in a vacuum evaporator may be on the order of 1-10 hours, to enable biochemical reactions (e.g., particulate hydrolysis, biomass synthesis, etc.), the retention time of the solids fraction and microbial cells must be considerably longer than that (e.g., >10 hours). This can be accomplished by using the evaporation process in the vacuum-integrated reactor or vacuum-integrated treatment unit as a means to decouple the solids fraction retention time from the soluble fraction retention time, and further to decouple solids fraction retention time, liquid non-volatile retention time, and liquid volatile retention time. To achieve optimal performance, one or more variables such as temperature, pH, pressure, mass-transfer, microbial communities, nutrients, and particulate fraction retention time can be simultaneously taken into account and controlled.

The vacuum-integrated reactor or vacuum-integrated treatment unit upstream or downstream from a conventional reactor described herein thus enables the selective removal of the one or more soluble fractions from the treatment chamber by vacuum evaporation, which enables the efficient decoupling of the retention time of the one or more soluble fractions from the retention time of the one or more solids fractions. This way, using vacuum as the main mechanism for removing mass and free up volume in the treatment chamber, it is possible to keep the one or more solids fractions in the treatment chamber for a theoretically infinite period of time, due to their relatively insoluble and non-volatile physico-chemical characteristics. Therefore, the one or more solids fractions will not be collected in the condensate, keeping the condensate exceptionally pure and nutrient-free.

In addition, in order evaporate volatile constituents and water, thus achieving the decoupling of HRT and SRT, the vacuum reactor or treatment unit could make use of the energy (heat and pressure) already provided to the mixture in the HTP stage. Essentially, water evaporation and volatile stripping will be achieved by the change in pressure and temperature between HTP and the evaporation vessel where vacuum is applied, whereas the efficiency of the evaporation and stripping could be further enhanced by adjustment of pH and conductivity in the mixture.

The HTP and vacuum-integrated reactor or reactor and vacuum-integrated treatment unit can be adopted into a wastewater treatment plant with biological nutrient removal units.

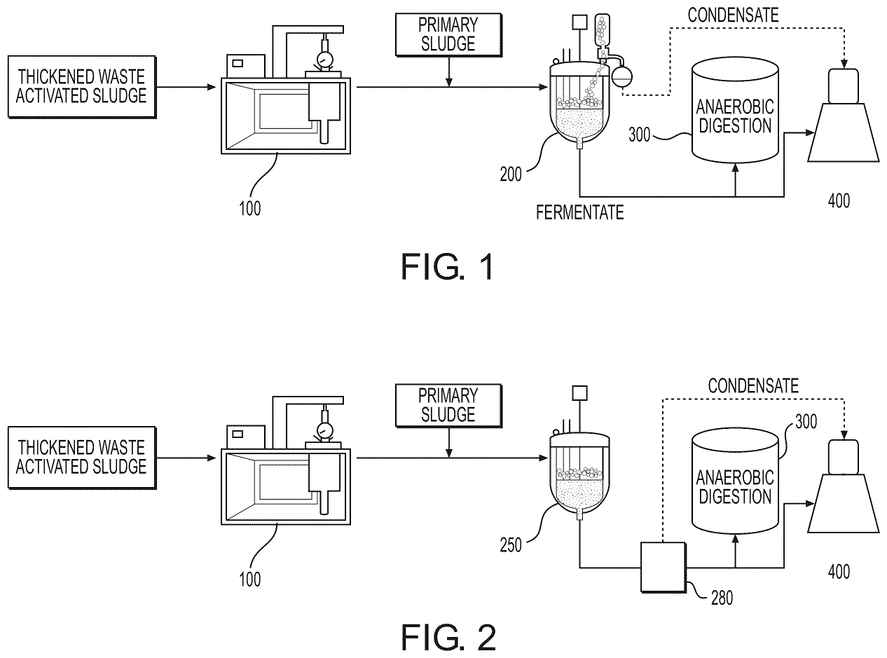

FIG. 1 illustrates a system including both a hydrothermal treatment apparatus 100 and a vacuum-integrated reactor 200 in a system including a downstream anaerobic digester 300. In this case, the downstream anaerobic digestion can occur as in conventional treatment systems. The digestion can be optimized, including with respect to retention time and value-added solids product recovery, in view of the treated fluid already having been subjected to removal of most of the volatile portions, including water, as well as removal of digestion inhibiting compounds such as ammonia, in the hydrothermal treatment apparatus and vacuum-integrated reactor. Specifically, the downstream anaerobic digestion can obtain additional gases from the biomass, further enhancing recovery and production of methane and/or hydrogen.

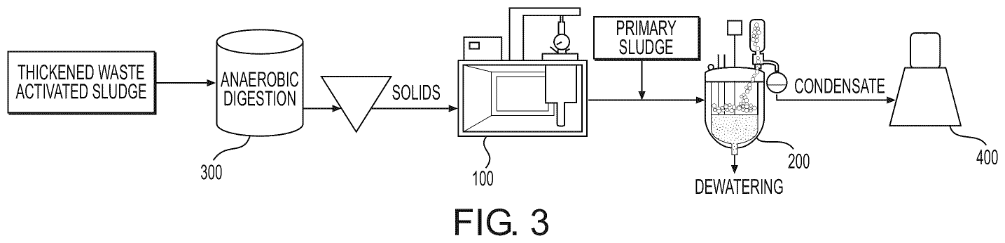

FIG. 2 illustrates a system including a hydrothermal treatment apparatus, a reactor 250 (without a vacuum) and a downstream vacuum-integrated treatment unit 280. The vacuum-integrated treatment unit may be an anaerobic digester, particularly where the reactor is a fermenter. Thus, the treatment unit 280 and anaerobic digester shown in FIG. 3 may be a single unit. Also, as discussed above, the vacuum-integrated treatment unit may be located upstream of the reactor.

FIG. 3 illustrates a system including both a hydrothermal treatment apparatus 100 and a vacuum-integrated reactor 200 in a system including an upstream anaerobic digester 300. As shown in FIG. 3, the fermentate from the vacuum-integrated reactor (in this case a fermenter) can be subjected to any further needed or desired dewatering (i.e., centrifuges), and any liquid recovered in the dewatering can be returned to the anaerobic digestion or vacuum-integrated reactor. Also, a recycle portion of the fermentate from the vacuum-integrated reactor can be recycled to the anaerobic digester.

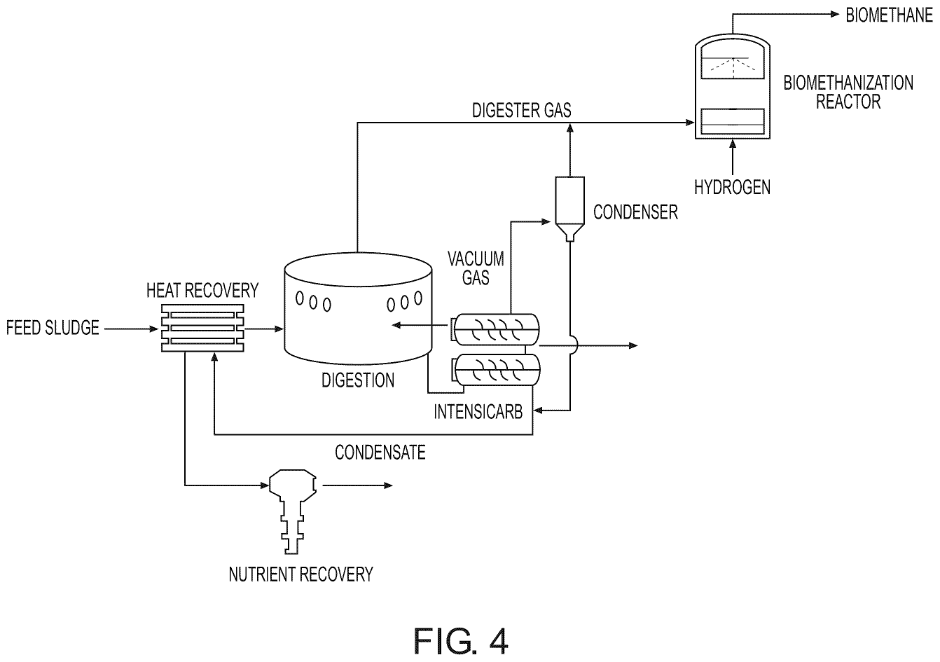

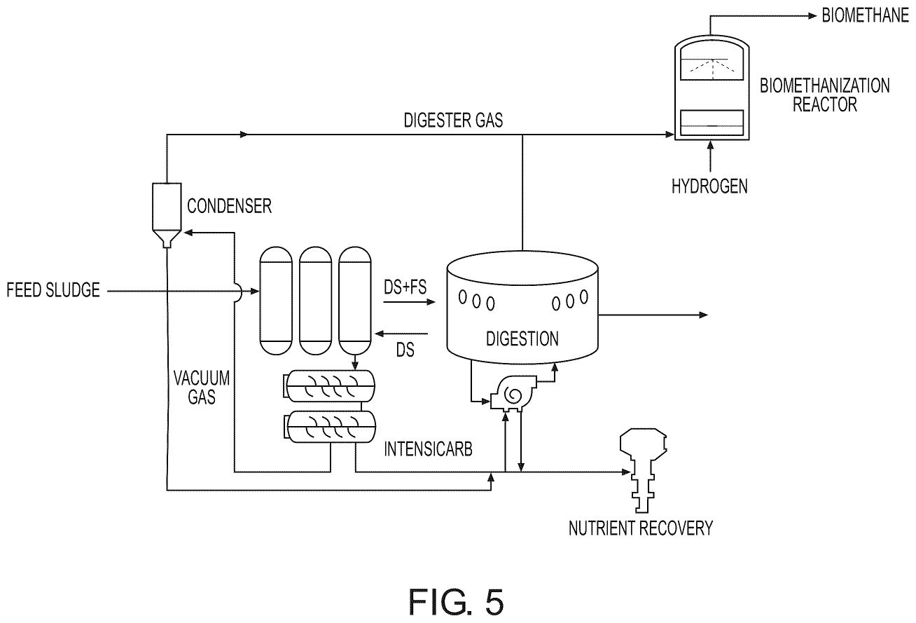

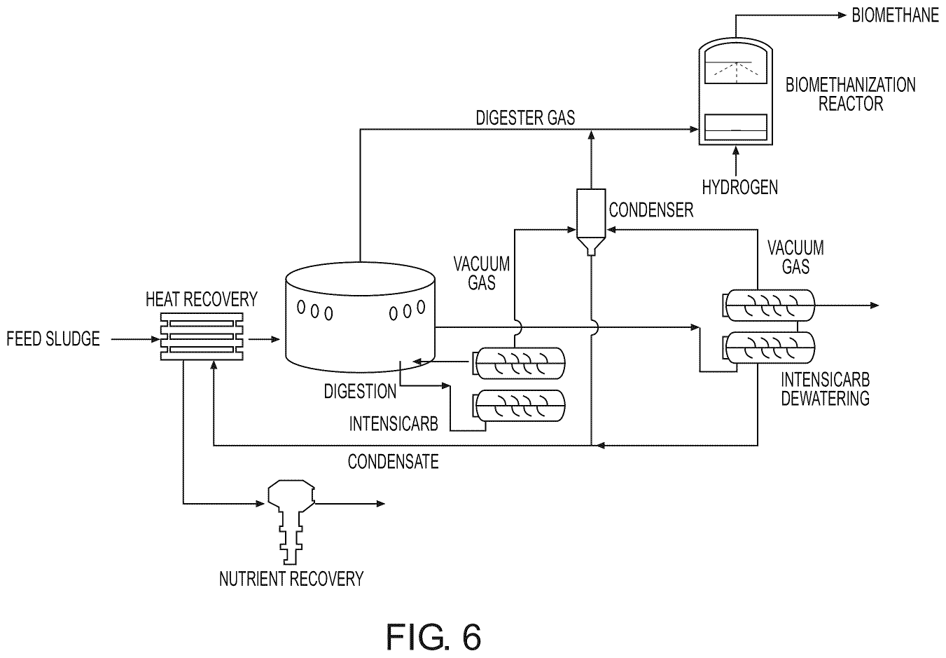

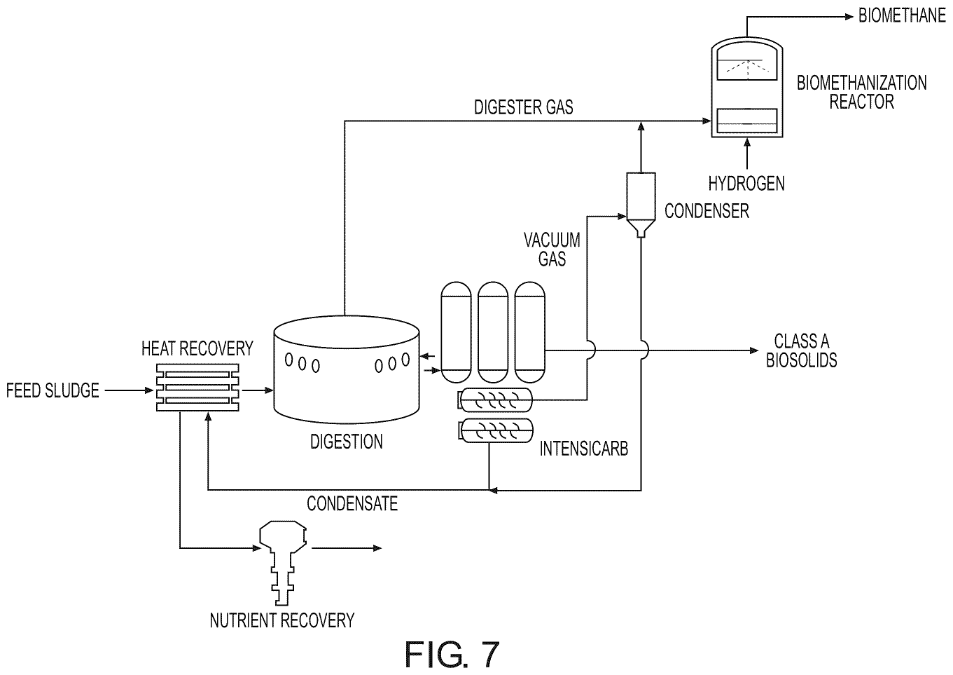

FIGS. 4-7 illustrate specific example systems employing both hydrothermal treatment, in this case with heating derived through means including heat recovery from condensate extracted from the digestion process, and vacuum digestion, shown using an IntensiCarbTM vacuum. In these systems, the biomethanization reactor supplements methane production using bio-hydrogen stripped from the digestate by the IntensiCarbTM vacuum and from other biogenic sources augmenting the conversion of recovered carbon dioxide to methane from the unit. In FIG. 5, a pre-pasteurization unit and vacuum is applied ahead of the digester, as a pretreatment for the purpose of pre-hydrolysis and pasteurization to assist in achieving recovery of Class-A biosolids from the digester. In FIG. 6, a second IntensiCarb™ vacuum may be deployed downstream of a digester to effect dewatering. In FIG. 7, post-pasteurization tanks are used after digestion to achieve Class-A biosolids.

The system and method can be used to recover one or more value-added products from the system. Many value-added products potentially present in wastewater and biosolids (precious metals, nutrients, cellulose, coagulants, pharmaceutical compounds, personal care products, etc.) are non-volatile and would tend to accumulate in the treatment system, thus facilitating the extraction and further purification to high-purity chemicals. In a conventional anaerobic digestion process, the efficiency of the process and the quality of the biosolids produced is mainly due to the biological activities. In the present process, a new biosolids with high quality will produced because of many factors such as combined biological, thermal and mechanical processes. In addition, separating a portion of the water and extracting volatile compounds by vacuum will produce new solids not only rich in nutrients and/or high solids content but also with new compositions.

The possibility of operating vacuum-based digestion or fermentation without regularly removing solids from the system allows the technology to be operated for an optimal period of time and under optimal thermodynamic conditions. Such optimal time and operating conditions could be selected to maximize the accumulation of certain compounds, such as cellulose, with the aim of recovering the accumulated material. The same concept can be applied to other valuable products such as nutrients, microbial products, precious metals, etc.

Volatile fatty acids and ammonia products may be selectively obtained using flash heating and flash pH adjustments in conjunction with temperature and vacuum - volatile fatty acids and ammonia are valuable products of anaerobic digestion. In conventional digesters or fermenters, which have continuous feed entering and digestate/fermentate leaving the digester/fermenter, the VFA and ammonia concentrations in the reactor do not accumulate to high concentrations. In the present system and method, because of the lack of digestate/fermentate and discontinuous condensate, the concentrations in the reactor reach much higher levels than in conventional digesters/fermenters. When the VFA and ammonia reach high levels, flash heating and/or pH adjustment with vacuum can facilitate the recovery of high purity condensates rich in VFA and/or ammonia.

Fertilizers may be recovered by dosing chemicals in a vacuum-based and temperature-assisted digestion process. As a result of the extremely long SRT possible in the process, the biosolids are expected to be fully stabilized, i.e., Class A biosolids. In this process, once the biosolids reach complete stabilization, chemicals such as potassium can be precisely dosed to achieve the desired NPK (nitrogen: phosphorous: potassium) ratio for commercial-grade fertilizers. In contrast to a conventional digester, even if it has the same stabilization efficiency as the vacuum-based digester, the chemical dosing system has to be continuously operated.

Fractionation and selective extraction of gases and volatile compounds from the biosolids treatment process is also possible. The gases and volatiles produced in the digester or fermenter have varying vapor pressures which, due to the cyclical nature of the vacuum evaporator operation, can be more or less removed by deploying sequential vacuum gradients, resulting in the partially-selective removal and condensation of volatiles. The application of vacuum can enhance the stripping of dissolved anaerobic digestion gases from the reactor, including carbon dioxide, hydrogen, ammonia, hydrogen sulfide, among others. The stripping / removal of these different gases impacts a number of aspects related to the digester, both directly and indirectly including: (1) removal of carbon dioxide (an acid gas) causes the sludge pH to rise. In this way, the digester pH can be controlled to where production of volatile fatty acids is maximized; otherwise, pH tends toward over-acidification to where production of alcohols and ketones are favored (solventogenesis); (2) removal of hydrogen (a key component for methane production) causes a shift toward fermentative microbes (acid-formers), which causes VFA levels to accumulate and methane production to slow down; (3) hydrogen is also needed by sulfate-reducing bacteria, and so removal of hydrogen reduces the rate of hydrogen sulfide generation. Removal of hydrogen sulfide (a metal-binding agent) frees up essential micronutrients (iron, cobalt, nickel) for exocellular production of hydrolytic enzymes, and so accelerates the fermentation process; (4) removal of ammonia (a microbial inhibitor) prevents its accumulation in the reactor, allowing long solids retention times without experiencing inhibited methane production; (5) removal of volatile fatty acids (an important supplemental carbon source) prevents its further conversion to methane in the reactor, allowing its recovery to support plant processes such as biological phosphorus removal and denitrification. Thus, by controlling the pH, temperature, and vacuum, certain of these gases can be made more or less volatile so that they are more or less selectively removed from the reactor. Thus, the above-described advantages can be selectively controlled.

In addition to the foregoing advantages from the use of a vacuum-integrated reactor or vacuum-integrated treatment unit, the further inclusion of HTP prior to the vacuum-integrated reactor or vacuum-integrated treatment unit is novel, and combining the use of HTP and a vacuum-integrated reactor or vacuum-integrated treatment unit reduces the viscosity and mixing issues brought about by thickening in the vacuum reactor. HTP increases the intensification potential of the reactor. It has been found that fermentation and AD reactors integrated with HTP contain a high amount of ammonia that inhibits the acetogenesis and methanogenesis activity, thus resulting in lower VFAs and methane production, given that during the HTP a high amount of ammonia is released. However, by integrating HTP with vacuum-integrated reactors or vacuum-integrated treatment units , ammonia is continuously recovered. The recovered ammonia not only improves the digester/fermenter performance but also captures ammonia that can be used for other purposes.

The diversity of the microbial community can also be reduced by HTP, thus eliminating methanogens in the vacuum reactor when used as a fermenter. In a conventional fermenter, methanogens can inhibit the acetogenesis process while in a vacuum fermenter integrated with HTP, methanogens cannot survive the high temperature (for example over 70° C.). Incorporating HTP into a system with a vacuum-integrated reactor thus also increases organic matter solubilization, VFA yield and ammonia yield. Hydrolysis is the rate limiting step in conventional digesters, while at 170° C., HTP solubilizes the organic compounds up to, for example, 40%, overcoming this challenge. The vacuum reactor or vacuum-integrated treatment unit further solubilizes the materials and ultimately higher amounts of VFA and ammonia are produced and recovered.

The subject matter herein will be further illustrated by way of the following examples.

### EXAMPLE 1

The substrate employed in this Example was thickened waste activated sludge (TWAS) obtained from Ashbridge's Bay Wastewater Treatment Plant in Toronto, Canada. Hydrothermal treatment of the substrate was performed under six different conditions—the temperature was fixed at 170° C. and six retention times of 10, 20, 30, 40, 50, and 60 min were tested. A Parr 4848 Hydrothermal Reactor with a capacity of 2 L (Parr Instrument Company, IL, US) was used for the HTP. The volume of the TWAS for each treatment was 1 L.

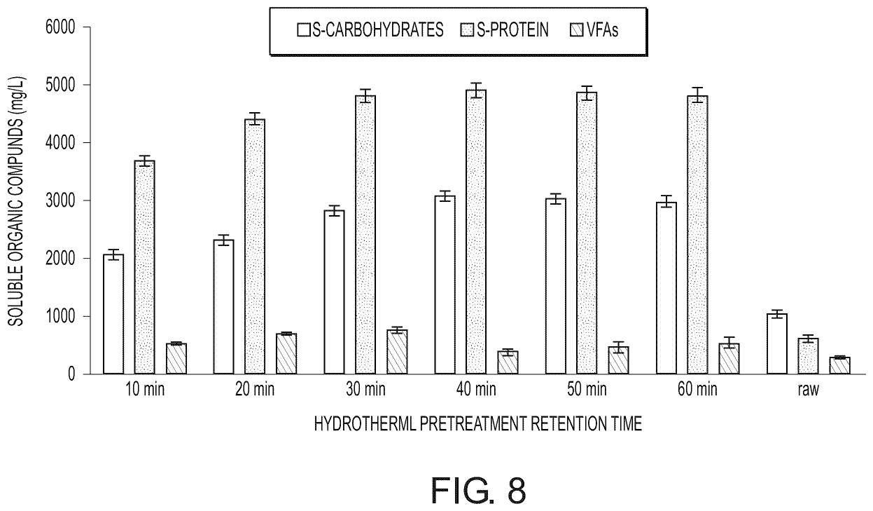

All the treated samples had a higher content of soluble compounds compared to a raw untreated sample. FIG. 8 illustrates the different soluble components, such as the VFAs, soluble carbohydrates, and soluble protein concentrations, for the treated and raw untreated samples. Comparing the soluble content in the raw sample to the hydrothermally treated samples, it was evidenced that the HTP has increased the concentration of all the soluble compounds.

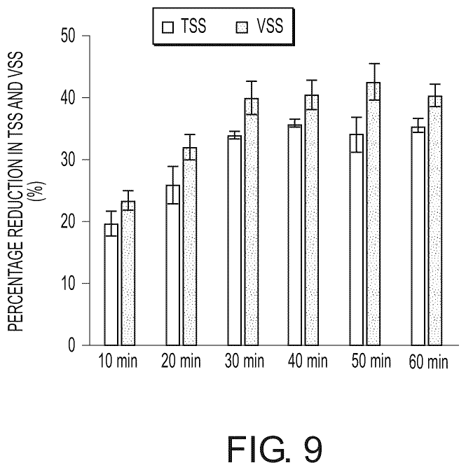

The percentages reduction in TSS and VSS due to the hydrothermal treatment are illustrated in FIG. 9. As shown in the figure, increasing the retention time up to min caused an increase in solids reduction, and it was stabilized afterwards. The TSS reduction of the hydrothermally pretreated samples ranged from 20% to about 35%. On the other hand, the VSS reduction ranged from 23% to about 40%. The VSS reduction of 23% was achieved at a retention time of 10 min; this percentage increased to 32% at a retention time of 20 min and reached the maximum of 40% at a retention time of 30 min. The VSS reduction did not change significantly after a retention time of 30 min.

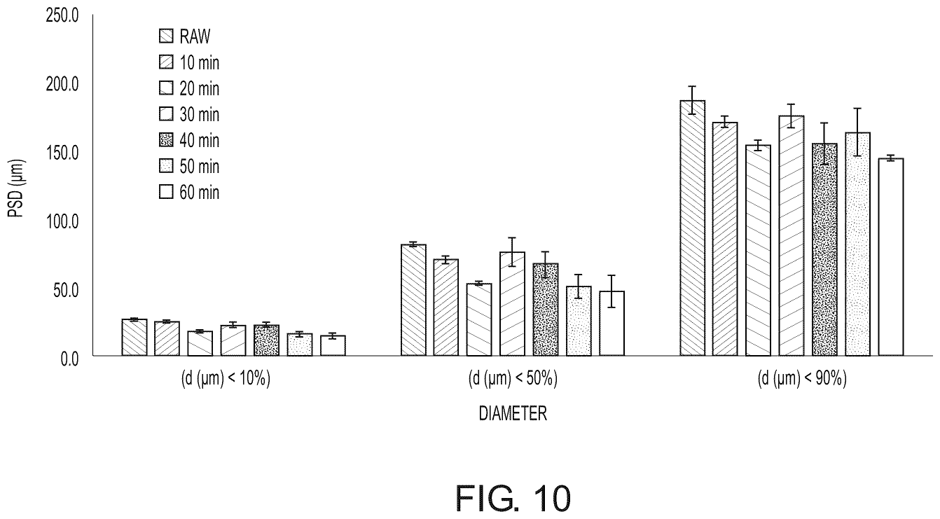

FIG. 10 illustrates the particle size distribution (PSD) of the raw and the hydrothermally treated samples. As shown in the figure, all the treated samples had a lower particle size compared to the raw sample. The d10 and d90 of the raw sample were 27 and 187 μm, respectively. Those values decreased to 15 and 125 μm for the pretreated samples. Increasing the retention time was associated with a decrease in the particle size of the pretreated samples (p<0.05). The lowest particle size was observed for the sample pretreated for 60 min. At a retention time of 60 min, the d10, d50, and d90 were 15.2±2.4, 47.8±11.8, and 145.5±1.7 μm, respectively, which accounted for a 45%, 42%, and 22% decrease in the particle size compared to the raw sample.

### EXAMPLE 2

The substrate employed in this Example was thickened waste activated sludge (TWAS) and primary sludge (PS) obtained from Ashbridge's Wastewater Treatment Plant in Toronto, Ontario. The substrate employed went through secondary treatment and thickening. The inoculum used was also obtained from the anaerobic digestion (AD) tank at Ashbridge Plant that operates at a mesophilic temperature range (34-38° C.) and HRT of 18 days for the sludge. The properties of raw TWAS and inoculum are shown in Table 1. Return activated sludge (RAS) was collected from the Greenway wastewater treatment plant (London, Ontario) and used as a source of biomass for the denitrification test. Detailed characterization of the RAS is also summarized in Table 1.

TABLE 1

| Parameter | Unit | TWAS | PS | Seed | RAS |
|---|---|---|---|---|---|
| TCOD | g/L | 34.2 ± 1.2 | 38 ± 2 | 22.4 ± 1.4 | 8.7 ± 0.4 |
| SCOD | g/L | 1.5 ± 0.02 | 2.2 ± 0.01 | 0.6 ± 0.1 | 0.21 ± 0.01 |
| TSS | g/L | 29.4 ± 1.2 | 26 ± 2.5 | 16.5 ± 0.5 | 8.8 ± 0.7 |
| VSS | g/L | 21.3 ± 0.5 | 15 ± 1.2 | 11 ± 0.2 | 6.2 ± 0.5 |
| VFA | g acetate/L | 0.8 ± 0.1 | 1.2 ± 0.1 | 0.06 ± 0.05 | 0.3 ± 0.01 |
| Total | g/L | 1.86 ± 0.1 | 3.7 ± 0.2 | 0.99 ± 0.08 | ND* |
| Carbohydrates | | | | | |
| Total Protein | g/L | 2.8 ± 0.05 | 1.9 ± 0.1 | 3.3 ± 0.05 | ND* |
| Soluble | g/L | 0.51 ± 0.02 | 0.3 ± 0.02 | 0.35 ± 0.04 | ND* |
| Carbohydrates | | | | | |
| Soluble | g/L | 0.6 ± 0.01 | 0.1 ± 0.01 | 0.35 ± 0.01 | ND* |
| Protein | | | | | |
| Ammonia | g N/L | 0.017 ± 0.01 | 0.05 ± 0.002 | 0.67 ± 0.03 | 0.02 ± 0.002 |
| Alkalinity | g CaCO₃/L | 1.55 ± 0.03 | 0.3 ± 0.04 | 5.8 ± 0.3 | 0.25 ± 0.01 |
| pH | — | 6.8 ± 0.1 | 5.7 ± 0.1 | 7 ± 0.02 | 6.7 ± 0.1 |

ND*: Not determined

Both raw and treated sludges were fed to the fermentation process to evaluate the effect of HTP in conventional and vacuum mode. Therefore, four systems were evaluated: S1=conventional fermentation (no HTP or vacuum) fed with raw TWAS and PS; S2=vacuum-integrated reactor fermentation fed with raw TWAS and PS; S3=HTP with conventional fermentation fed with HTP treated TWAS and raw PS; and S4=HTP+vacuum-integrated reactor fermentation fed with HTP treated TWAS and raw PS. HTP of TWAS was performed at temperature: 170° C., holding time: 30 min: pressure 6 bar.

S4 enables enhanced biochemical fermentation and simultaneous thickening of municipal biosolids vacuum-driven evaporation of the processed sludge at temperatures between 20-60° C. This process combines thickening, hydrolysis, acidification, gas stripping, and dewatering via a nearly ideal solid-liquid separation, such that the biochemical and physico-chemical treatment processes are intensified. The intense bubbling in vacuum boiling intensifies the mass transfer rate among gas, liquid, and solids components. In contrast, mass removal by vacuum evaporation allows complete retention of nonvolatile soluble fractions (including nutrients such as ammonia and phosphates) of fermented biosolids. Ancillary units for heat recovery are integrated with the vacuum evaporation chamber to recycle latent heat of evaporation back into the process. The complete system is comprised of the following components: (1) a heat exchanger to pre-heat the feedstock using the recovered latent heat of evaporation, (2) the main reactor vessel operating under vacuum (which can perform both fermenting and thickening processes of the biosolids), (3) a vacuum pump to extract the vapor produced during evaporation, (4) a second heat exchanger to recover heat available in the fermented sludge.

S1 was fed with 50:50 (on a volumetric basis) of raw PS and TWAS, while S3 was fed with a mixture of hydrothermally treated TWAS and raw PS (50:50). The semi-continuous conventional fermentation systems were operated under thermophilic conditions (45° C.). The conventional fermenter (SRT=HRT=3 days) was operated by wasting 1/3rd of sludge (500 mL) the 1.5 L fermentate volume. Both Si and S3 were started by mixing 1 liter of thermally pretreated seed (heated at 70° C. for 30 min to suppress the methanogenesis) and 0.5 liters of feed.

S2 and S4 (SRT=3 days, HRT=1.5 days) were operated by applying vacuum for 10 hours daily with -900 mBar pressure (or +100 mBar absolute pressure, equivalent to a boiling temperature of 45° C.), to evaporate 1,500 mL of the 3L fermentate volume. To maintain the same SRT as the conventional control fermenter S1 (3 days), one-third (1/3rd) of the sludge volume remaining after evaporation was wasted daily and replaced with fresh mixed sludge. Between vacuum applications, S2 and S4 were maintained at 45° C. using a water bath, and pressure and temperature were continuously monitored during vacuum operations. All systems S1-S4 were operated until pseudo-steady state conditions were reached.

The condensate (high-grade VFAs) were tested for the applicability as a carbon source for denitrification test, and the fermentates were used as a feed for anaerobic digestion (AD). To assess the impact of HTP and vacuum on fermentate and condensate as carbon sources for biological nutrient removal, a series of batch tests were conducted to enhance denitrification. These samples included fermentate of both conventional and vacuum systems fed by raw and treated samples. Also, condensate of vacuum systems and supernatant of the fermentate was used as a carbon source. To avoid carbon limitation during the test, the soluble chemical oxygen demand (COD)-to-nitrate ratio was retained at a minimum of 8:10. Mixed liquor suspended solids (MLSS controls) or the RAS without additional carbon sources were also tested to check for background denitrifying activity (MLSS controls). To compare and analyze the SDNR of the external carbon sources with the commonly used commercial carbon source, acetate was also fed to one of the reactors in the batch series.

Fermentate and center of the fermentate from the four systems were used as the substrate for biochemical methane potential (BMP) tests. The samples' methane production rate and biodegradability fraction were determined using BMP tests.

Water and gas quality analysis, including total suspended solids (TSS), volatile suspended solids (VSS), total chemical oxygen demand (TCOD), soluble chemical oxygen demand (SCOD), carbohydrates, proteins, VFAs, biogas production, and biogas composition, were analyzed. The viscosity of the samples was measured on a Fungilab™ Viscolead One Viscometer using L3-spindle and 100 rpm rotation speed (Fungilab Inc.).

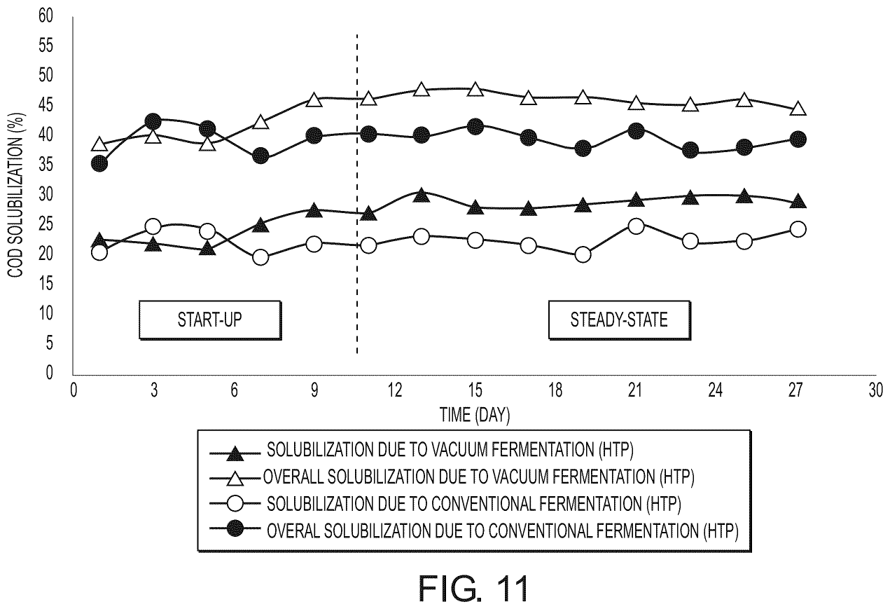

Both hydrothermal treatment and vacuum fermentation significantly impacted the sludge disintegration as the sole factor and combined (p>0.005). FIG. 11 illustrates the changes in chemical oxygen demand (COD) solubilization by time in the conventional and vacuum fermentation reactor fed by HTP treated sludge. As observed in the figure, higher solubilization accrued in the vacuum fermentation reactor compared to the conventional fermenter. Vacuum fermentation demonstrated a 10-15% improvement in COD solubilization compared to the conventional fermentation during the steady-state phase. Further, the overall COD solubilization ranged between 44-47% for the vacuum fermentation and 35-40% for the conventional fermentation. The overall COD solubilization includes solubilization due to HTP (25-30%) and fermentation.

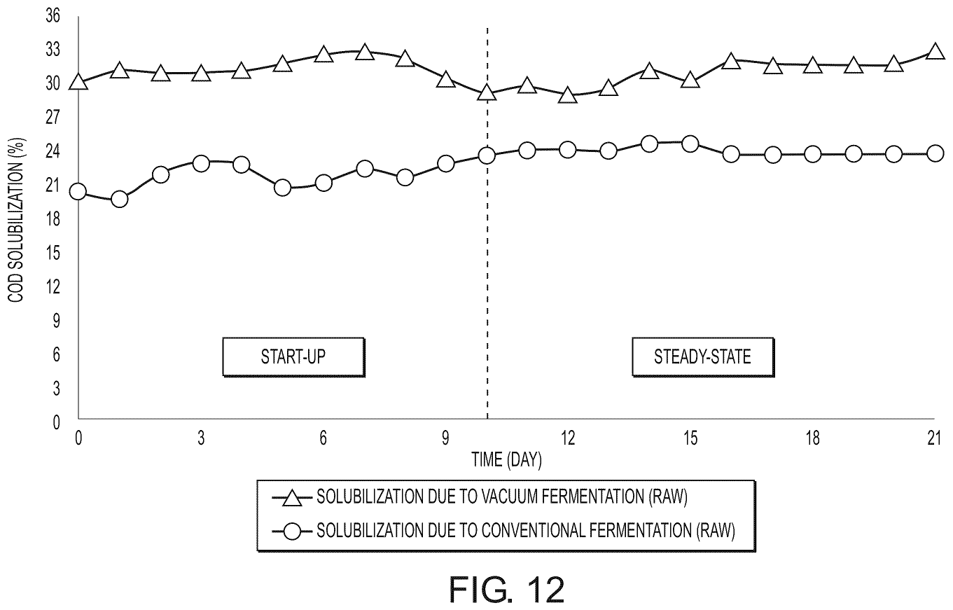

On the other hand, studying two fermentation reactors (conventional and vacuum) fed by the raw sludge, the advantage of vacuum fermentation over conventional is emphasized. FIG. 12 shows the changes in COD solubilization of sludge by the time in two reactors (vacuum and conventional). 25-30% improvement was detected in vacuum reactor compared to the conventional. The higher disintegration rate in vacuum fermentation over conventional could be due to the lower pressure in the vacuum reactor and consequently higher stress on the biomass cell walls. Also, extraction of the liquid from vacuum fermentation could be another factor since the solid content of the vacuum reactor increases over time. The sludge accumulation can help retain higher sludge volume/solids in the reactor.

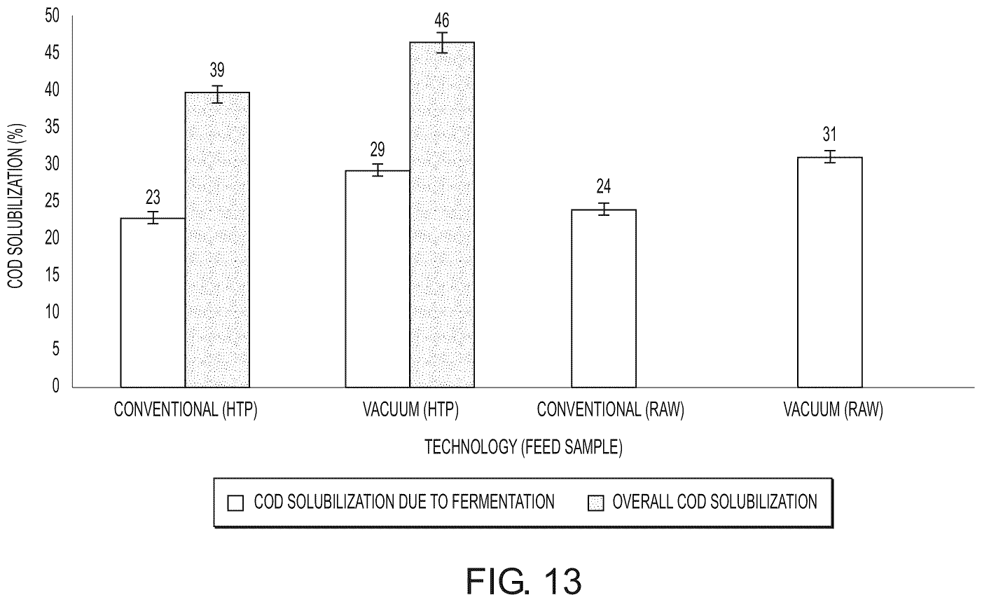

Furthermore, results revealed that hydrothermal treatment integration with vacuum fermentation significantly improves the overall sludge hydrolysis (p>0.005), while its impact on fermentation is similar to the raw feed. FIG. 13 reports the average COD solubilization for all four systems for comparison. The figure shows that both vacuum fermentation systems, either fed by HTP treated sludge or raw, had almost similar efficiency of 29 and 31% solubilization due to fermentation only. On the other hand, the overall COD solubilization of the HTP treated feed in the vacuum reactor due to the HTP and fermentation is 32% higher than the raw fed reactor. This percentage implies that most solubilization has occurred during HTP rather than fermentation.

To conclude, the HTP with vacuum fermentation can potentially lead to a higher hydrolysis rate, increase the solid reduction efficiency, and reduce the energy required to heat the fermenter as the HTP treated TWAS provides additional heat fermenter. For example, with an insulation system and minimum heat loss, the heated substrate can be sufficient to maintain the fermenter temperature to the desired temperature or reduce the energy input for heating the fermenter.

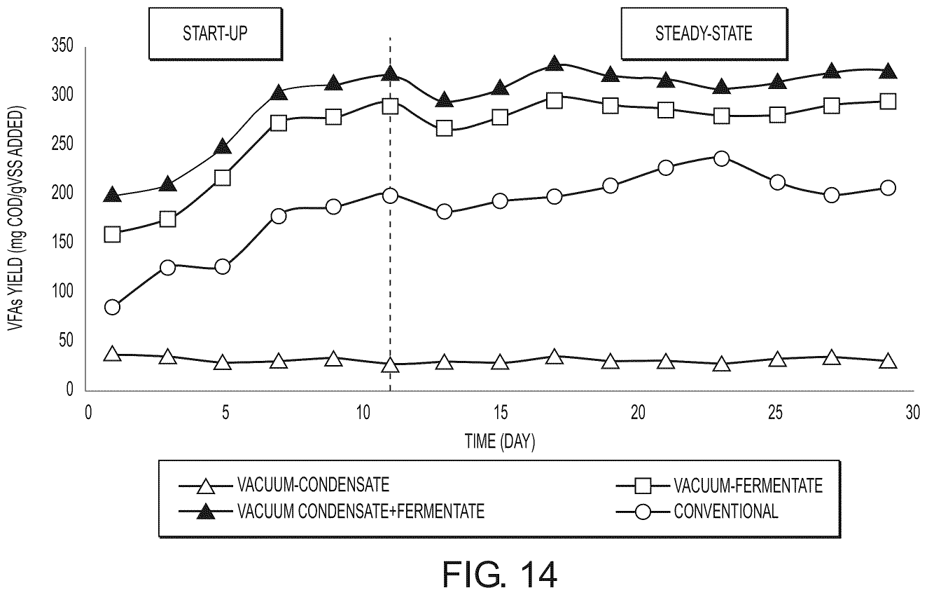

A significant difference in VFA yield (p>0.005) was observed in the current study for the four systems. Further, vacuum, and hydrothermal pretreatment integration demonstrated superior results to those without vacuum and pretreatment. FIG. 14 shows the variation of VFA yield by time for the treated samples in a conventional and vacuum-integrated reactor for the fermentate, condensate, and overall fermentate+condensate. No apparent lag phase was observed during both fermentation processes, and VFA yield gradually increased throughout the fermentation process, reaching the plateau in the steady-state phase. This graph compares VFAs yield of the novel configuration of integrated HTP -vacuum-integrated reactor with conventional fermentation fed by HTP treated sample, highlighting the impact of vacuum application on the VFA increasing it by approximately 30% considering both VFA produced from both condensate plus fermentate of the integrated system.

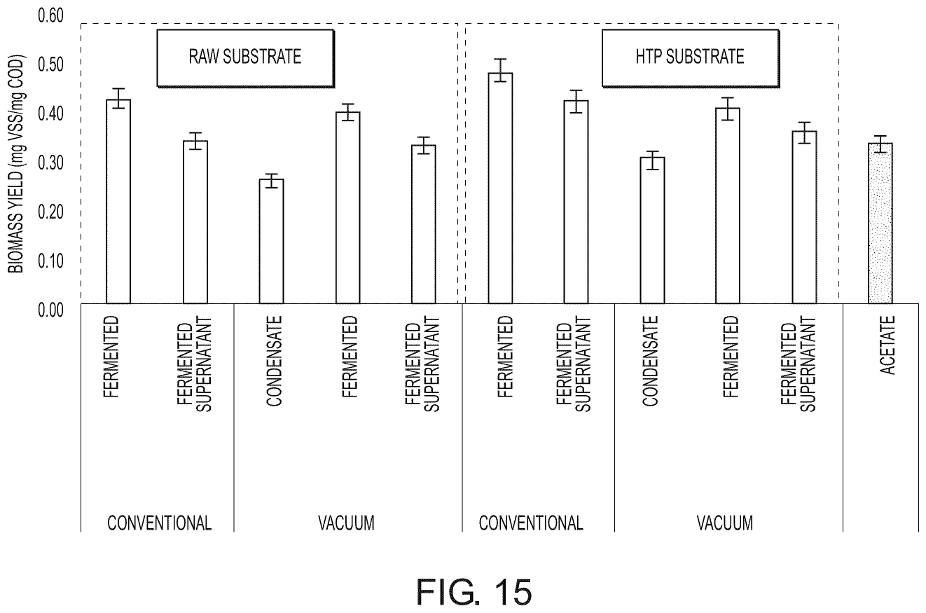

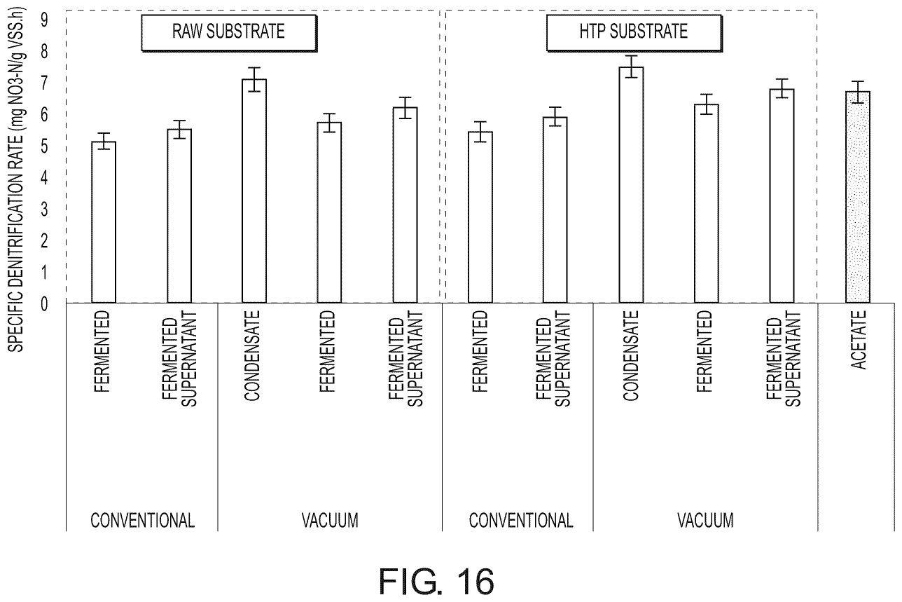

Biological nutrient removal processes in wastewater plants require carbon sources produced biologically on-site. VFAs produced during fermentation are a great source of biological carbon source. In this Example, the effluents of four different fermentation systems were tested to be used as a potential carbon source for denitrification. Also, all four reactors' fermentate was centrifuged to achieve a pure liquor with low solid content (supernatant) and used as a carbon source. The specific denitrification rate (SDR) and the biomass yield for all these carbon sources are shown in FIGS. 15 and 16, respectively. Results reveal that the condensate of the S2 and S4 reactors without and with HTP treatment has the highest specific denitrification rate of 7.6 and 7.2 mg NO₃-N/g VSS·h, compared to all other samples and control (acetate), respectively. The high efficiency of the condensate could be due to the presence of highly biodegradable compounds (high-grade VFAs) and low solid concentration. Additionally, due to low biomass concentration in the condensate, the only active bacteria are denitrifiers. On the other hand, the fermented samples contain fermentative bacteria changing the diversity of bacteria in the process hence mitigating the denitrification rate.

Moreover, HTP improved the denitrification process regardless of the fermentation reactor configuration. All the reactors containing the HTP treated samples demonstrated slightly higher SDR (up to 10%) compared to the systems fed with raw TWAS. Furthermore, carbon sources from S2 and S4 were revealed to accelerate the denitrification rate compared to conventional reactors. Production of high-grade VFAs and higher concentration of VFAs due to the simultaneous removal of inhibitory compounds such as ammonia could be the most significant factor in the higher efficiency of S2 and S4 effluent. During vacuum fermentation, ammonia is removed, and a higher concentration is produced, which could be further recovered through different approaches. Ammonia production by itself counts as another advantage of vacuum fermentation. Lastly, the integration of vacuum and HTP was associated with higher ammonia production as well, which adds to the benefits of this novel process integration due to the potential of nutrient recovery to a large extent through ammonia stripping and other routes.

Furthermore, the depletion of nitrate and COD by time demonstrated superior results for HTP treated and vacuumed samples compared to the raw. All HTP treated samples were associated with a higher nitrate removal rate as the peak of nitrite occurred in 45 minutes compared to the acetate and raw, which were delayed to 60 and 120, respectively.

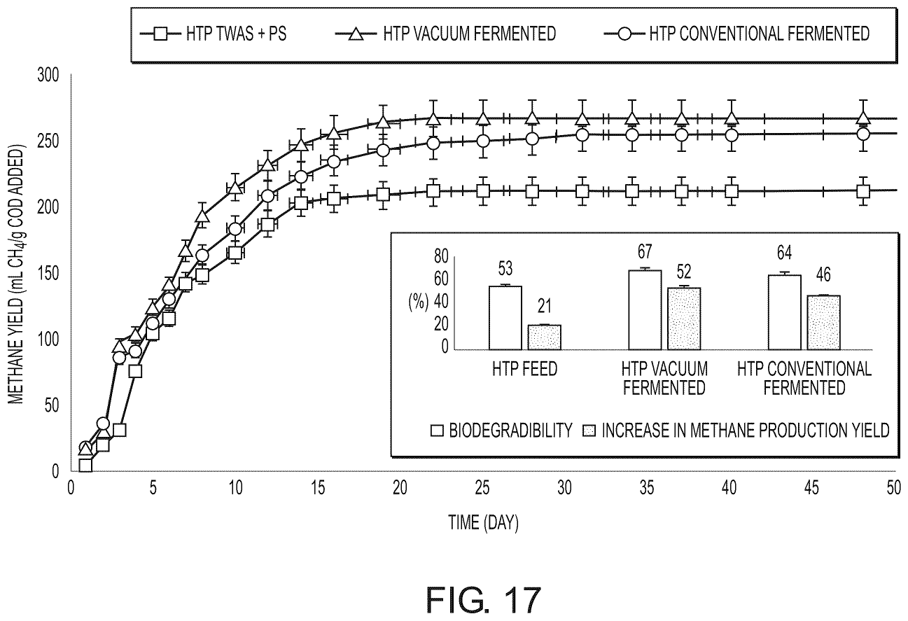

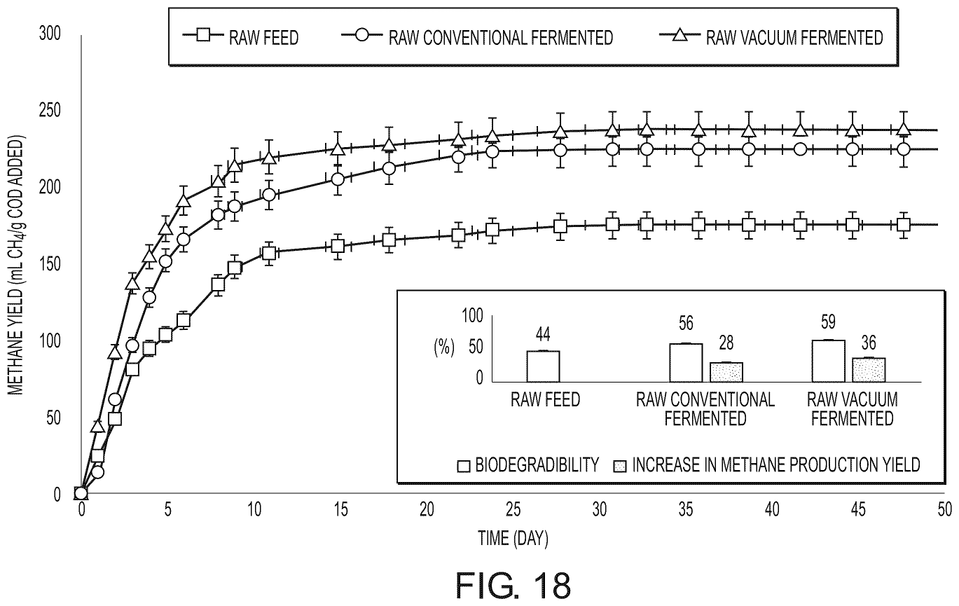

BMP results revealed that the novel configuration of HTP and vacuum-integrated reactors promotes hydrolysis and VFA production and considerably enhances the methane production yield. FIGS. 17 and 18 show the cumulative methane production yield by time for the four systems. As seen in both figures, hydrothermally treated samples generally demonstrated higher enhancement potential than the raw samples. Methane yield for the samples that have gone through HTP and fermentation increased by 46-59% compared to the raw feed. Further, comparing the impact of HTP for each fermentation reactor, the raw conventional fermented sample had a lower methane yield of 225 mL CH₄/g TCOD added compared to the HTP conventional fermented sample (255 mL CHCH₄/g TCOD added). Similarly, in S2 and S4, treated samples were associated with a higher methane yield of 267 mL CH₄/g TCOD added than the raw vacuum fermented of 237 mL CHCH₄/g TCOD added.

The conventional fermentation contributed to methane production enhancement, but vacuum fermentation demonstrated a higher impact on methane production improvement. Neglecting the HTP impact, raw conventional fermented sample and raw vacuum fermented exhibited 28% and 36% increase in methane yield compared to raw, which signifies the impact of the integrated system (HTP+vacuum) on AD performance.

Likewise, the biodegradability of the samples improved by applying HTP and vacuum. The biodegradability of both systems fed with the raw sample was lower (56-59%) than the two systems fed with HTP treated samples (64-67%), implying the advantage of the HTP regardless of the fermentation reactor configuration.

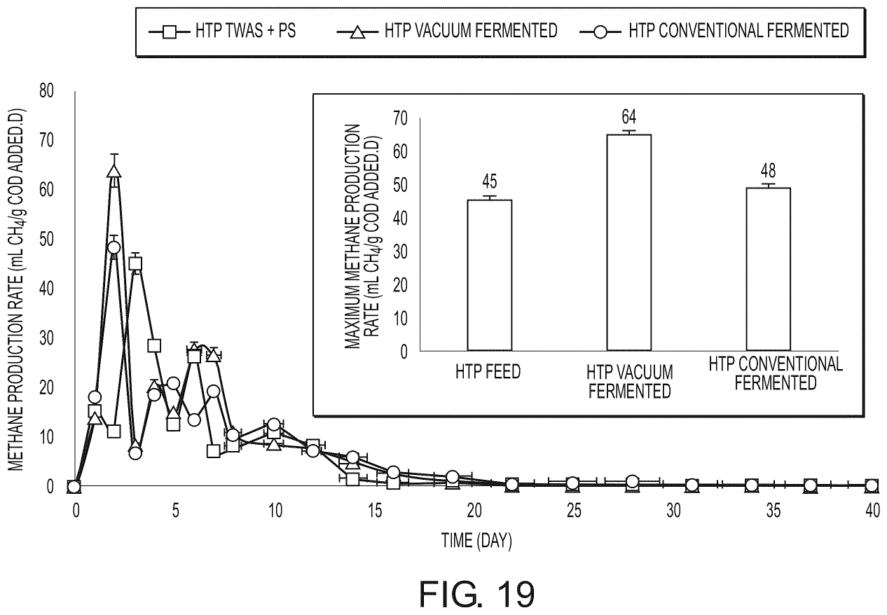

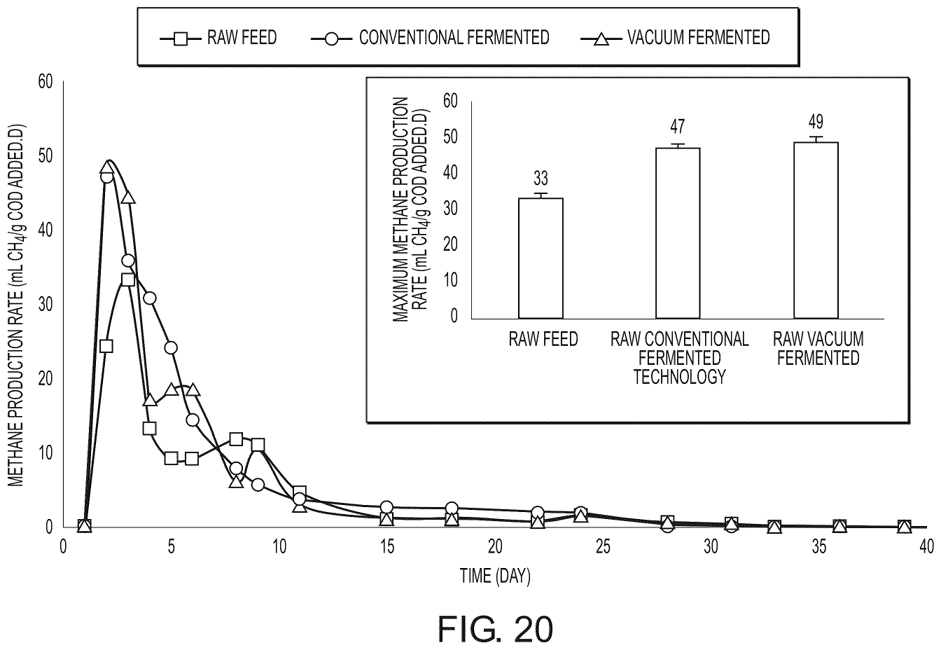

In a batch BMP test, besides the methane production yield, the methane production rate is a crucial process response parameter to evaluate the biodegradability of the substrates. The HTP treated and raw feed's methane production rates are shown in FIGS. 19 and 20. Given that the source of the inoculum and substrates were the same, no apparent lag phase was observed for all samples. Two major peaks were observed throughout the BMP test for all the samples. The first peak associated with maximum methane produced were between day 2-4 for pretreated samples and 2-3 for raw samples. The second minor peaks were detected in week 2 of the test while slowly biodegradable organics began to degrade. Moreover, the methane production rate for the HTP treated sample was evidenced by detecting maximum methane production of 64 mL CHCH₄/g COD added.

Furthermore, BMP data revealed application of vacuum enhances the methane production rate up to 25% compared to the conventional reactor with no vacuum. The maximum methane production for the HTP treated sample in the vacuum reactor was 64 mL CH₄/g COD added while it dropped to 48 mL CH₄/g COD added in a conventional reactor. The role of vacuum application in improving the methane production rate could be related to the high solubilization during vacuum fermentation due to high heat and microbial activities, ultimately producing a large amount of readily biodegradable compounds for AD. In conclusion, the novel configuration of HTP and vacuum reactors improved VFAs production and demonstrated excellent results in terms of methane production rate and yield.

From this Example, integration of vacuum in the fermentation reactor led to the following benefits: (1) vacuum application enhanced the mass transfer due to bubbling as the reactor operates above the boiling point, together with the possibility of simultaneously concentrating the solids and evaporating the liquid; (2) enhanced the fermentation process performance due to removing the inhibitory substances produced during the fermentation processes. VFAs yield increase by about 40% by vacuum application; (3) controlled the acid accumulation due to the continuous extraction of VFAs from the system. Integration of HTP with vacuum fermentation led to the following additional benefits: (1) accelerated the fermentation process and reduce the required HRT to 1.5 day; 92) enhanced the fermentation productivity, i.e., higher VFAs yields of 330 mg COD/g VSS for vacuum (with HTP) compared to 210 mg COD/g VSS for conventional (with HTP); (3) enhanced the degree of solubilization (45% for vacuum (with HTP) and 39% for conventional (with HTP)) and increased the solids reduction efficiency; and (4) reduced the energy required to heat the fermenter as the pretreated TWAS provides additional heat to the fermenter, i.e., with an excellent insulation system and minimum heat lost; the heated substrate can be sufficient to maintain the fermenter temperature to the desired temperature or at least reduce the energy input for heating the fermenter.

### EXAMPLE 3

The novel configuration of the hydrothermal treatment and vacuum fermentation was investigated for microbial community, comparing the application vacuum fermentation vs. conventional and HTP treatment and no HTP treatment integration. In the investigation, each semi-continuous system was operated using similar conditions in terms of HTP (170° C. temperature and 30 min RT) and HRT (1.5 days) using feeds of TWAS+raw PS, running for about 20 days.

Genomic DNA was extracted from the biomass using the PowerSoil DNA isolation kit (MoBio Laboratories Inc.). The DNA samples were sent to the Genome Quebec Research and Testing Laboratory in Montreal, Québec for 16S rRNA gene sequencing (IIlumina MiSeq). The DNA samples were amplified using PCR for amplicon preparations. The V3-V4 region of the 16S rRNA gene was amplified using primers 347F (GGAGGCAGCAGTRRGGAAT) and 803R (CTACCRGGGT ATCTAATCC). A second PCR reaction was performed to incorporate sample specific barcodes. The DNA concentration of all PCR reactions was measured using Picogreen so that the equimolar concentration of all samples could be used for sequencing. The amplicon library with an insert size of about 450 bases was sequenced with a paired-end 250 kit (Illumina MiSeq). 16S rRNA gene sequences were used to generate an operational taxonomic unit (OTU) table and a corresponding FASTA file. Analysis was performed by the Canadian Centre for Computational Genomics at McGill University. The GenPipes version 4.0.0 (Bourgey et al., 2019) amplicon-seq pipeline was used to perform analyses. This pipeline is based on the DADA2 package in the R environment. First, the trimming was done using Trimmomatic (Bolger et al., 2014), taking off 16 bp from the start of the reads. Then, 5,308,340 paired-end reads passed the quality-filtering parameters applied [truncLen=c(234,234); max N=0; max EE=c(2,2); trunc Q=2] with an average value of 186,983 reads/sample and thus were merged (minimum overlap of 20 bp) and subjected to de novo chimera removal. Taxonomy was assigned to the resulting amplicon sequence variants (ASVs) using Silva database version 123.

Results revealed bacteria were abundant microorganisms observed in all four systems (no HTP, no vacuum; no HTP, vacuum; HTP, no vacuum; and HTP, vacuum). The most abundant type of bacteria is Coprothermobacteraeota followed by Synergistetes, Thermotogae, and Firmicutes which are mainly anaerobic bacteria growing in the thermophilic conditions (55° C.-70° C.). The presence of these bacteria denotes the anaerobic condition was well maintained during the experiment. All the above-mentioned bacteria were not detected in the feed.

Alpha diversity measures evaluated the richness in the diversity of microbial communities comparing between the control and vacuum fermentation reactors. The number of observed Amplicon Sequence Variant (ASV) in both systems was gradually decreasing by the fermentation time indicating lower diversity in the systems as fermenters grew to be the dominant microbial communities. The ASV of all systems were decreased during the steady-state compared to start-up indicating the good performance of reactors (fermenters). Furthermore, the vacuum application showed a great impact on the alpha diversity. For all the sample points, the ASV for the vacuum reactors was lower than the conventional reactor by 15-20%. Considering the steady-state data, the average ASV value for the vacuum and conventional reactors were 14 and 16, respectively. In general, 10 types of phyla were detected for the fermented samples in both reactors while the presence of a lower number of phyla in vacuum reactors confirmed the impact of the vacuum on the variation of the microbial structure. Two major phyla (Coprothermobacteraeota and Synergistetes) grouped the major bacteria present in all samples, followed by Firmicutes, Thermotogae, Actinobacteria, and Euryachaeota being the next relative abundant phyla. Also, as the pH of reactors increased during fermentation the Euryarchaeota phylum, which belongs to archaea and is responsible for methane production, was completely inhibited. The average relative abundance of the coprothermobacteraeota in a vacuum and conventional systems during the steady-state phase of the fermentation were 75% and 65%, respectively, while in contrast for Synergistetes it was 15% and 25%, respectively demonstrating the favorable condition for each phylum.

Hydrothermal treatment impacted the diversity of the microbial communities significantly given the significant difference between the number of observed ASV. The ASV of the HTP treated samples was higher than the raw samples regardless of the fermentation technology. About 12% and 20% enhancement was observed for the ASV values of the HTP treated samples from the vacuum and conventional systems, respectively, compared to the raw samples. The richness in diversity of HTP treated samples could be due to the changes in the chemical composition of the feed and the elimination of the bacteria present in TWAS during the HTP. Furthermore, results from Alpha diversity analysis revealed that the type of fermentation reactor is a crucial factor for microbial diversity richness while systems are fed by HTP treated sludge. On the contrary, the type of technology did not play a prominent role in microbial community diversity without hydrothermal treatment. Moreover, microbial relative abundance analysis further proved the influence of the HTP on the microbial communities and enrichment of specific bacterial communities. The dominant type of bacteria found for HTP treated samples from both systems and raw for the vacuum system were Coprothermobacteraeota and Synergistetes, while on the other hand, Thermotogae and Synergestetes were the most abundant phyla for raw-conventional samples. HTP has been demonstrated to nourish and accelerate thermophilic bacteria growth.

In addition to the fermenters and hydrolytic bacteria, small communities of methanogenesis and nitrifiers were observed with a low percentage. The low relative abundance of the archaea and bacteria such as Euryarchaeota (methane producers) and Planctomycetes (nitrifier) indicate the excellent performance and configuration of fermentation mitigating the function and growth rate of inhibitory microbial communities.

Bacteria were dominant microbial communities in all systems studied. The microbial community analysis revealed that the application of vacuum fermentation significantly impacted microbial diversity and composition. This impact was evidenced by the lower ASV values for the vacuum compared to the conventional reactors and the presence of a large community of Coprothermobacteraeota and Synergistetes phyla in the vacuum systems. Furthermore, the hydrothermal HTP treatment enriches the thermophilic microbial communities and has higher ASV values than the raw samples.

Although specific embodiments were described herein, the scope of the invention is not limited to those specific embodiments. The scope of the invention is defined by the following claims and any equivalents therein. As will be appreciated by one skilled in the art, aspects of the present disclosure may be embodied as an apparatus, system or method.

The diagrams in the Figures illustrate the architecture, functionality, and operation of possible implementations of apparatuses and methods according to various embodiments of the present disclosure. In this regard, each block or feature in the Figures may represent a module, segment, or portion of the method or apparatus, and the functions noted therein may occur out of the order noted in the Figures. For example, two blocks or features shown in succession may, in fact, be executed substantially concurrently, or the blocks or features may sometimes be executed in the reverse order, depending upon the functionality involved.

What is claimed is:

1. A method for treating a fluid that includes a particulate fraction and a soluble fraction, the method comprising:
feeding the fluid to a hydrothermal treatment apparatus and subjecting the fluid to heating to a temperature of 121° C. or more to obtain treated fluid;
subsequently feeding the hydrothermally treated fluid to a reactor, wherein at least the particulate fraction is subjected to fermentation or anaerobic digestion, wherein the treated fluid is subjected to vacuum pressure upstream in a process direction from the fermentation or anaerobic digestion, during the fermentation or anaerobic digestion, or downstream in a process direction from the fermentation or anaerobic digestion;
wherein if the vacuum pressure is applied during the fermentation or anaerobic digestion, the reactor is a vacuum-integrated reactor, and the method includes collecting from the vacuum-integrated reactor at least a portion of the soluble fraction of the fluid including water and gases as condensate and residual gases and thereby thickening a remaining portion of the fluid;
wherein if the vacuum pressure is applied upstream or downstream from the fermentation or anaerobic digestion in a vacuum-integrated treatment unit, the method includes collecting from the treated fluid or from the treated and fermented or digested fluid at least a portion of the soluble fraction of the fluid including water and gases as condensate and residual gases and thereby thickening a remaining portion of the fluid; and
recovering the thickened fluid.

2. The method according to claim 1, wherein the reactor is a vacuum-integrated reactor selected from among a vacuum-integrated fermenter and a vacuum-integrated digester.

3. The method according to claim 1, wherein the heating in the hydrothermal treatment apparatus is at 130 to 300° C. for 5 to 100 minutes.

4. The method according to claim 3, wherein the heating in the hydrothermal treatment apparatus is done under a pressure of 2 to 10 bar.

5. The method according to claim 1, wherein the fluid is thickened waste activated sludge with a solids content of 1% to 16%.

6. The method according to claim 1, wherein before subsequently feeding the hydrothermally treated fluid to the reactor, the treated fluid is mixed with an additional fluid that includes a particulate fraction and a soluble fraction that has a higher degree of biodegradability than the fluid.

7. The method according to claim 1, wherein the fermentation is conducted under mesophilic, thermophilic, or hyperthermophilic conditions with a temperature range of 20 to 100° C. and a pH of from 3-10.

8. The method according to claim 1, wherein the vacuum pressure is from 10 to 750 mbar.

9. The method according to claim 2, wherein the vacuum pressure is from 10 to 750 mbar. The method according to claim 9, wherein the vacuum is applied intermittently during the fermentation or anaerobic digestion.

11. The method according to claim 1, wherein heat is extracted from the condensate and used to provide heating to the fluid in the hydrothermal treatment apparatus.

12. The method according to claim 1, wherein the recovered thickened fluid is subjected to further processing comprising one or more of anaerobic digestion, dewatering and post-pasteurization.

13. The method according to claim 1, wherein the condensate is subjected to further processing comprising denitrification or biomethanization.

14. The method according to claim 1, wherein prior to the feeding the fluid to the hydrothermal treatment apparatus, the fluid is subjected to a treatment selected from the group consisting of anaerobic digestion and pre-pasteurization.

15. The method according to claim 1, wherein the method further comprises feeding at least a portion of the recovered thickened fluid to a biological nutrient removal process.

16. The method according to claim 1, wherein the method further comprises, prior to the feeding of the hydrothermally treated fluid to the reactor, cooling the hydrothermally treated fluid to 75° C. or less.

17. The method according to claim 1, wherein water evaporation and volatile stripping is achieved by a change in pressure and temperature between the hydrothermal treatment apparatus and the vacuum-integrated reactor or vacuum-integrated treatment unit, and efficiency of the evaporation and volatile stripping is further enhanced by adjustment of pH and conductivity in the treated fluid.

18. A method for treating wastewater fluid that includes biosolids, the method comprising:
feeding the wastewater fluid to a hydrothermal treatment apparatus and subjecting the fluid to heating to a temperature of 121° C. or more to obtain treated fluid;
subsequently feeding the treated fluid to a reactor, wherein the wastewater fluid is subjected to fermentation or anaerobic digestion, wherein the treated fluid is subjected to vacuum pressure upstream in a process direction from the fermentation, during the fermentation or anaerobic digestion, or downstream in a process direction from the fermentation or anaerobic digestion;
wherein if the vacuum pressure is applied during the fermentation or anaerobic digestion, the reactor is a vacuum-integrated reactor, and the method includes collecting from the vacuum-integrated reactor gases as condensate;
wherein if the vacuum pressure is applied upstream or downstream of the fermentation or anaerobic digestion in a vacuum-integrated treatment unit, the method includes collecting from the treated fluid or from the treated and fermented or digested fluid gases as condensate; and extracting heat from the condensate and using the extracted heat to provide heating to the wastewater fluid in the hydrothermal treatment apparatus.

19. The method according to claim 18, wherein the reactor is a vacuum-integrated reactor selected from among a vacuum-integrated fermenter and a vacuum-integrated digester.

20. A system for treating a fluid that includes a particulate fraction and a soluble fraction, the system comprising:
a hydrothermal treatment apparatus configured to treat a fluid fed therein by heating,
downstream in a process direction from the hydrothermal treatment apparatus, a reactor configured to receive the treated fluid from the hydrothermal treatment apparatus, to subject the treated fluid to fermentation or anaerobic digestion, wherein the reactor is selected from a vacuum-integrated reactor having a vacuum pump for applying a vacuum to the vacuum-integrated reactor and a reactor without a vacuum pump,
wherein if the reactor is a reactor without a vacuum pump, the system further includes a vacuum-integrated treatment unit, upstream and/or downstream in a process direction from the reactor, that includes a vacuum pump for applying a vacuum to the vacuum-integrated treatment unit, and
wherein using the vacuum, condensate is removed; and
a controller configured to control the vacuum and removal of the condensate and control a residence time of the particulate fraction in the reactor to be at least 25% greater than a residence time of the soluble fraction.

21. The system according to claim 20, wherein the reactor is a vacuum-integrated reactor selected from among a vacuum-integrated fermenter and a vacuum-integrated digester.

22. The system according to claim 20, further comprising a heat exchanger that extracts heat from the condensate and provides the extracted heat to the hydrothermal treatment apparatus.

23. The system according to claim 20, further comprising at least one of an anaerobic digester and a pre-pasteurization apparatus upstream, in a process direction, from the hydrothermal treatment apparatus.

24. The system according to claim 20, further comprising, downstream, in a process direction, from the vacuum-integrated reactor at least one of an anaerobic digester, a dewatering device and a post-pasteurization apparatus for further processing of fermentate from the vacuum-integrated reactor.

25. The system according to claim 20, further comprising, downstream, in a process direction, from the vacuum-integrated reactor at least one of a denitrification device or a biomethanization device for further processing of the condensate removed from the vacuum-integrated reactor.
